(19) United States
(12) Patent Application Publication
(10) Pub. No.: US 2003/0058438 A1
(43) Pub. Date: Mar. 27, 2003

(54) Test socket with structural optical window

(76) Inventor: Charles J. Koehler, San Jose, CA (US)

Correspondence Address: BERNHARD P. MOLLDREM, JR., 2ND FLOOR, MONROE BUILDING, 333 EAST ONONDAGA STREET, SYRACUSE, NY, 13202, US

(21) Appl. No.: 10/235,396

(22) Filed: Sep. 4, 2002

Related U.S. Application Data
(60) Provisional application No. 60/317,383, filed on Sep. 6, 2001.

(51) Int. Cl. G01N 21/01

(52) U.S. Cl. 356/244

(57) ABSTRACT

A test socket receives an optical-electronic device which has optical elements at an upper side and electrical elements at a lower side. The test socket assembly has a lower portion in which electrical connectors connect to pin electrodes of the device to be tested. The electrical connectors can be spring loaded. An upper portion is movable down onto the lower portion to restrain the device to be tested in the lower portion. The upper portion has an optical window transparent to a wavelength of interest for contacting against the upper side of the device to be tested.

### BACKGROUND OF THE INVENTION

This invention concerns test sockets for use in electrical testing of optical microelectronic components and devices.

There is currently a need to test optical electronic components and devices, where the component itself can be subjected to a number of electrical conditions with respect to the various pins and also at the same time can be optically actuated by applying light through an optical window onto a photosensitive element or elements on the device. At present this involves soldering or affixing the device in circuit. Thus it is desired to achieve some means for removably placing the device in a test situation so that it can be tested or calibrated.

### OBJECTS AND SUMMARY OF THE INVENTION

It is an object to provide a test socket, with an optical window arrangement, that allows the test technician to overcome the drawbacks of the prior art.

The problem that is solved is that of testing small optical microelectronic devices, which poses the restrictions of physical containment to assure reliable electrical connection, while simultaneously providing adequate exposure of the device to prevent interference by the test socket in the optical stimulation or measurement.

In an aspect of the invention, the socket comprises one piece that contains the electrical connections and a second piece containing a light transmissive optical window that clamps together with the first piece. The optical microelectronic Device Under Test, or DUT, is enclosed between the two pieces, and is electrically connected to the external test electronics. In the socket the light transmissive optical window is used as a constraint, i.e., constraining element, in containing the DUT within the socket. The window applies pressure to the DUT to compress onto the electrical connections in the first piece of the socket. During the DUT test sequence, light is beamed through the optically transmissive window onto the DUT, enabling the device to be tested optically and electrically. Optionally, the DUT can be a light emitting device, and is stimulated to emit light, with the light being beamed through the optically transmissive window to a light measurement instrument located in the optical path.

The optical window may preferably be sapphire, which is hard and scratch resistant. The term “transparent” means that some wavelength of interest passes through it, and that need not be in the visible spectrum, but may be IR or UV. The window can pass only a narrow fraction of the entire spectrum. The window is preferably larger across than the device or DUT, so that there is no problem from reflections in the frame surrounding the window.

In this invention, an optical window is incorporated into a microelectronic component test socket. This optical window physically constrains the device under test such that the DUT is held in electrical contact with the electrical test connections while allowing light to pass through the same optical window (in one or both directions) in an unobstructed manner to facilitate testing of the optical microelectronic DUT.

### BRIEF DESCRIPTION OF THE DRAWING

FIGS. 1A to 1D illustrate a first embodiment of the invention with FIG. 1A being a side elevation; FIG. 1B a top plan of a window portion; FIG. 1C a top plan of a socket portion; and FIG. 1D another elevation.

FIGS. 2A to 2D illustrate a second embodiment of the invention with FIG. 2A being a side elevation; FIG. 2B a top plan of a window portion; FIG. 2C a top plan of a socket portion; and FIG. 2D another elevation.

### DESCRIPTION OF THE PREFERRED EMBODIMENTS

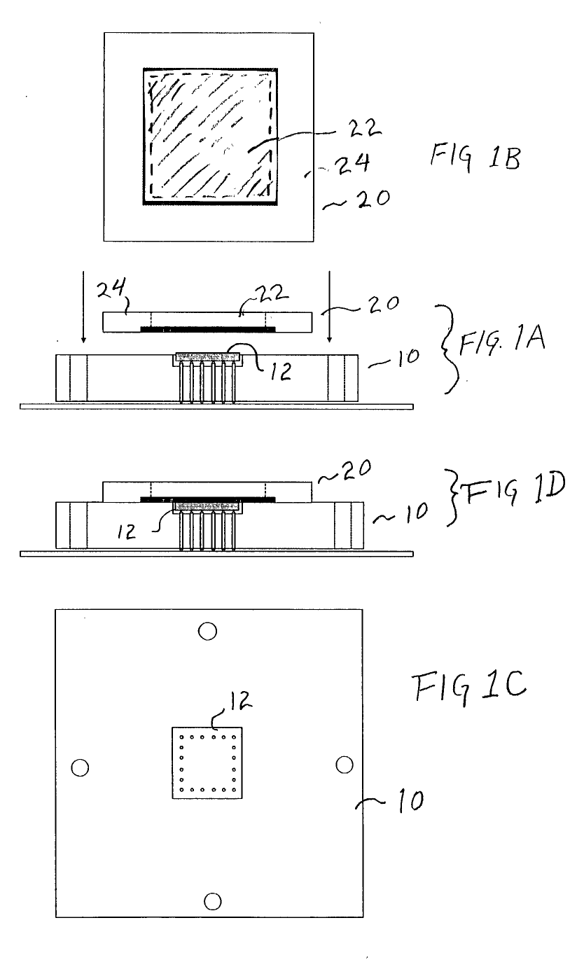

FIG. 1A shows one embodiment of the optical test socket of the invention, where a lower electrical socket portion 10 holds the DUT, with pins fitting into respective pin connectors, and with a recess 12 on top to hold the body of the DUT. The upper part 20 is urged downward onto the lower part 10 and DUT to hold the DUT in place. This part 20 (FIG. 1B) comprises a flat, transparent optical window 22, surrounded by a frame 24. The optical window 22 is significantly wider than the DUT, and avoids reflections from the inner wall of the frame 24. The lower part 10 is shown in plan in FIG. 1C. The glass, quartz, or sapphire window 22 rests directly against the top of the DUT (FIG. 1D) for restraining and testing the DUT.

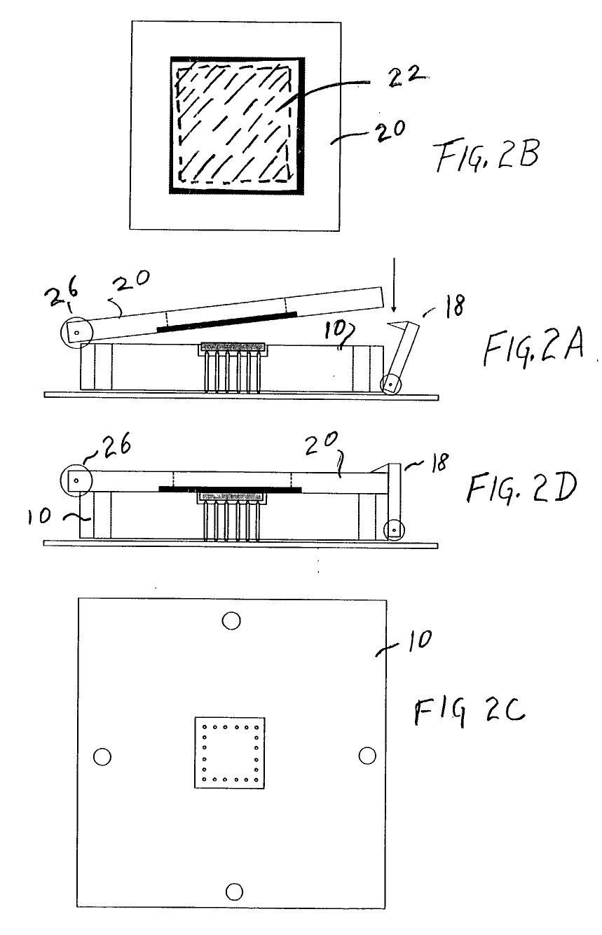

FIGS. 2A to 2D show an alternative embodiment, in which the upper part 20 closes in clamshell fashion over the DUT in the lower portion 10. The elements here that are the same as in the first embodiment are identified with the same reference numbers. In this case, the upper part 20 has a hinge 26 at one side, pivoting on that side of the lower portion. Opposite that is a hinged snap fastener 18 that keeps the upper part 20 held down. This is released by moving the fastener 18 to the right. Other arrangements are possible as well.

I claim:

1. A test socket for testing an optical device having optical elements at an upper side and electrical elements at a lower side, comprising a lower portion having electrical connectors for connecting to pin electrodes of the device to be tested, and an upper portion movable down onto the lower portion for restraining the device to be tested in the lower portion, the upper portion having an optical window transparent to a wavelength of interest for contacting against the upper side of the device to be tested.

2. The test socket of claim 1, in which said device to be tested has a predetermined width across its upper side, and said optical window is wider than said predetermined width.

3. The test socket of claim 1, in which the optical window is transparent to a selected band of wavelengths less than the entire visible spectrum.
